(19) United States
(12) Patent Application Publication
(10) Pub. No.: US 2016/0004574 A1
(43) Pub. Date: Jan. 7, 2016

(54) METHOD AND APPARATUS FOR ACCELERATING SYSTEM RUNNING

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventors: Yiping Liu, BEIJING (CN); Ye Tian, Beijing (CN); Xin Pu, Beijing (CN); Chong Li, Beijing (CN)

(21) Appl. No.: 14/769,385

(22) PCT Filed: Jan. 24, 2014
(86) PCT No.: PCT/CN2014/071396

§ 371 Date: Aug. 20, 2015

(30) Foreign Application Priority Data
Feb. 21, 2013 (CN) 201310055418.8

(51) Int. Cl. G06F 9/54; G06F 9/48; G06F 9/50; G06F 9/46

(52) U.S. Cl. CPC G06F 9/54; G06F 9/461; G06F 9/485; G06F 9/5016

(57) ABSTRACT

The invention discloses a method and apparatus for accelerating. It comprises a method and apparatus for accelerating. The method comprises: an acceleration enabling step of constructing and displaying an acceleration panel containing a one-key acceleration control when a preset enabling condition is triggered; and an acceleration execution step of detecting the one-key acceleration control within the acceleration panel in real time, and swapping memory occupied by all currently running processes to virtual memory to assist the system in running acceleration when the one-key acceleration control is triggered. The method and the apparatus of the invention can organize the system running condition for a user at a fastest speed, free redundant resources, increase the real-time system running speed of the user, and well solve the problem in the prior art that the system running speed can not be increased effectively.

### FIELD OF THE INVENTION

The invention relates to the field of network data communication technology, and in particular, to a method and apparatus for accelerating system running

### BACKGROUND OF THE INVENTION

With the increasing development of the PC (Personal Computer), applications of the PC are also gradually increased, which in turn results in that many unnecessary processes will be accumulated during the process of using the PC, resources such as memory, CPU, IO (input/output), etc. of a system will be occupied, the operation of the system will behave more and more slowly, and the startup of software will also need a long waiting time, thus greatly affecting the use by a user. For such a problem, currently, there are mainly the following several solutions: 1) freeing resources occupied by the system by closing unnecessary opened programs one by one; 2) invoking a resource manager of the system and manually ending unnecessary processes; and 3) logging off or restarting the computer.

However, for the above solution 1), since the system is already relatively slow, it will result in that the system will often be stuck during the operation and the operation is inconvenient; for the above solution 2), it is often required for the user to have the ability of discriminating processes, such that an ordinary user can not distinguish implications of numerous processes in the process management at all, and in turn can not choose therefrom; and for the above solution 3), it seriously affects the user to use and is a helpless choice.

It can be seen that all the above solutions can not effectively increase the running speed of the system. Therefore, currently, it becomes a technical problem urgently needs to be solved how to provide a solution that can provide all users with a simple and easy system running acceleration scheme and in turn increase the system running efficiency.

### SUMMARY OF THE INVENTION

In view of the above problems, the invention is proposed to provide a method for accelerating system running and a corresponding apparatus which can overcome the above problem or at least in part solve the above problem.

According to an aspect of the invention, there is provided a method for accelerating system running, comprising:

an acceleration enabling step of constructing and displaying an acceleration panel containing a one-key acceleration control when a preset enabling condition is triggered; and

an acceleration execution step of detecting the one-key acceleration control within the acceleration panel in real time, and swapping memory occupied by all currently running processes to virtual memory to assist the system in running acceleration when the one-key acceleration control is triggered.

Optionally, in the method of the invention,

the acceleration enabling step further comprises: scanning the system running environment to obtain currently running closeable processes and software according to a set reference when the preset enabling condition is triggered, and exhibiting the obtained closeable processes and software via the acceleration panel for a user to perform close selection; and

the acceleration execution step further comprises: closing a selected process and/or software within the acceleration panel and recycling memory and resources of the system when the one-key acceleration control is triggered.

Optionally, in the method of the invention, the acceleration enabling step further comprises:

invoking a pre-configured library file and obtaining a closeable process type and software type when the preset enabling condition is triggered; and

taking the obtained type information as a reference, scanning the system running environment to obtain currently running closeable processes and software, and exhibiting the obtained closeable processes and software via the acceleration panel for the user to perform close selection.

Optionally, in the method of the invention, the closeable process type configured in the library file comprises a non-system service process and a non-system security protection process.

Optionally, in the method of the invention, the acceleration enabling step further comprises: configuring a redundant process which does not affect the user to use to be in a close selected state by default when exhibiting the closeable processes and software in the acceleration panel.

Optionally, in the method of the invention, the redundant process which does not affect the user to use comprises: a software supporting process automatically running in a case of the software being not enabled.

Optionally, in the method of the invention, the acceleration enabling step further comprises: configuring a recorded process and/or software selected at the time of the user's previous acceleration selection to be in a close selected state by default when exhibiting the closeable processes and software in the acceleration panel.

Optionally, in the method of the invention, the acceleration enabling step further comprises: when the preset enabling condition is triggered, calculating a resource occupancy rate of each currently running process, and acquiring a current overall resource occupancy rate based on the resource occupancy rate of each process, displaying the resource occupancy in the constructed acceleration panel.

Optionally, in the method of the invention, the way of calculating the resource occupancy rate of each process comprises: obtaining a cpu occupancy amount X, a memory occupancy amount Y and an input/output IO occupancy amount Z of a process i, and calculating a resource occupancy rate Qᵢ of the process i based on the each obtained occupancy amount.

Optionally, after calculating the resource occupancy rate Qᵢ of each currently running process by the above described calculation way, each Qᵢ are summed to obtain a total resource occupancy rate Qₜₒₜₐₗ of currently occupied resources, and a value corresponding to the current resource occupancy rate Qₜₒₜₐₗ is displayed in real time in the constructed acceleration panel.

Optionally, in the method of the invention, the acceleration enabling step further comprises: when exhibiting the closeable processes and software in the acceleration panel, arranging them in an order from high to low in terms of resource occupancy rate; wherein the resource occupancy rate of the exhibited software is the sum of the resource occupancy rate of each process supporting the running of the software.

Optionally, in the method of the invention, the acceleration execution step further comprises: displaying the size of freed resources and the size of recycled memory in the acceleration panel after the acceleration execution is finished.

Optionally, in the method of the invention, in the acceleration enabling step, the way of judging that the preset enabling condition is triggered further comprises:

judging that the preset enabling condition is triggered when it is detected that a startup control laid in a functional area is triggered; or judging that the preset enabling condition is triggered when it is detected that a set time interval is reached; or judging that the preset enabling condition is triggered when it is detected that software is enabled;

wherein when it is detected that software is enabled, the startup of the software is paused, and after the execution of the acceleration execution step is finished, the software is run.

According to another aspect of the invention, there is provided an apparatus for accelerating system running, comprising:

at least one processor; and

one non-transitory computer readable medium coupled to the processor, the medium storing instructions that when executed by the processor cause the processor to perform operations for accelerating system running, which comprise:

an acceleration enabling step of constructing and displaying an acceleration panel containing a one-key acceleration control when a preset enabling condition is triggered; and

an acceleration execution step of detecting the one-key acceleration control within the acceleration panel in real time, and swapping memory occupied by all currently running processes to virtual memory to assist the system in running acceleration when the one-key acceleration control is triggered.

Optionally, in the apparatus of the invention,

the acceleration enabling step further comprises: scanning the system running environment to obtain currently running closeable processes and software according to a set reference when the preset enabling condition is triggered, and exhibiting the obtained closeable processes and software via the acceleration panel for a user to perform a close selection; and

the acceleration execution step further comprises: closing a selected process and/or software within the acceleration panel and recycle memory and resources of the system when the one-key acceleration control is triggered.

Optionally, in the apparatus of the invention, the acceleration enabling step further comprises: invoking a pre-configured library file and obtaining a closeable process type and software type when the preset enabling condition is triggered; and taking the obtained type information as a reference, scanning the system running environment to obtain currently running closeable processes and software, and exhibiting the obtained closeable processes and software via the acceleration panel for the user to perform the close selection.

Optionally, in the apparatus of the invention, the closeable process type configured in the library file invoked in the acceleration enabling step comprises a non-system service process and a non-system security protection process.

Optionally, in the apparatus of the invention, the acceleration enabling step further comprises: configuring a redundant process which does not affect the user to use to be in a close selected state by default when exhibiting the closeable processes and software in the acceleration panel.

Optionally, in the apparatus of the invention, the redundant process which does not affect the user to use comprises: a software supporting process automatically running in a case of the software being not enabled.

Optionally, in the apparatus of the invention, the acceleration enabling step further comprises: configuring a recorded process and/or software selected at the time of the user's previous acceleration selection to be in a close selected state by default when exhibiting the closeable processes and software in the acceleration panel.

Optionally, in the apparatus of the invention, the acceleration enabling step further comprises: when the preset enabling condition is triggered, calculating a resource occupancy rate of each currently running process, acquiring a current overall resource occupancy rate based on the resource occupancy rate of each process, and displaying the resource occupancy in the constructed acceleration panel.

Optionally, in the apparatus of the invention, the way of calculating the resource occupancy rate of each process comprises: obtaining a cpu occupancy amount X, a memory occupancy amount Y and a input/output IO occupancy amount Z of a process i, and calculating a resource occupancy rate Qᵢ of the process i based on each obtained occupancy amount.

Optionally, after calculating the resource occupancy rate Qᵢ of each currently running process by the above described calculation way, each Qᵢ are summed to obtain a total resource occupancy rate Qₜₒₜₐₗ of currently occupied resources, and a value corresponding to the current resource occupancy rate Qₜₒₜₐₗ is displayed in real time in the constructed acceleration panel.

Optionally, in the apparatus of the invention, the acceleration enabling step further comprises: when exhibiting the closeable processes and software in the acceleration panel, arranging them in an order from high to low in terms of resource occupancy rate; wherein the resource occupancy rate of the exhibited software is the sum of the resource occupancy rate of each process supporting the running of the software.

Optionally, in the apparatus of the invention, the acceleration execution step further comprises: displaying the size of freed resources and the size of recycled memory in the acceleration panel after the acceleration execution is finished.

Optionally, in the apparatus of the invention, the acceleration enabling step further comprises: judging that the preset enabling condition is triggered when it is detected that a startup control laid in a functional area is triggered; or judging that the preset enabling condition is triggered when it is detected that a set time interval is reached; or judging that the preset enabling condition is triggered when it is detected that software is enabled;

wherein when it is detected that software is enabled, the startup of the software is paused, and after the execution of the acceleration execution module is finished, the software is run.

According to yet another aspect of the invention, there is provided a computer program comprising a computer readable code which causes a computing device to perform the method for accelerating system running described above, when said computer readable code is running on the computing device.

According to still another aspect of the invention, there is provided a non-transitory computer readable medium having instructions stored thereon that, when executed by at least one processor, cause the at least one processor to perform operations for accelerating system running, which comprises the steps of

constructing and displaying an acceleration panel containing a one-key acceleration control when a preset enabling condition is triggered; and

detecting the one-key acceleration control within the acceleration panel in real time, and swapping memory occupied by all currently running processes to virtual memory to assist the system in running acceleration when the one-key acceleration control is triggered.

The beneficial effects of the invention lie in that:

the method and apparatus for accelerating system running according to the invention can organize the system running condition for a user at a fastest speed, free redundant resources, increase the real-time running speed of the system of the user, thus, the problem in the prior art that the system running speed can not be increased effectively is solved, and have prominent beneficial effects.

The above description is merely an overview of the technical solutions of the invention. In the following particular embodiments of the invention will be illustrated in order that the technical means of the invention can be more clearly understood and thus may be embodied according to the content of the specification, and that the foregoing and other objects, features and advantages of the invention can be more apparent.

### BRIEF DESCRIPTION OF THE DRAWINGS

Various other advantages and benefits will become apparent to those of ordinary skills in the art by reading the following detailed description of the preferred embodiments. The drawings are only for the purpose of showing the preferred embodiments, and are not considered to be limiting to the invention. And throughout the drawings, like reference signs are used to denote like components. In the drawings:

FIG. 1 shows a flow chart of a method for accelerating system running in embodiment one of the invention;

FIG. 2 shows a schematic diagram of an acceleration panel in an embodiment of the invention;

FIG. 3 shows a flow chart of calculating the resource occupancy rate in an embodiment of the invention;

FIG. 4 shows a flow chart of a method for accelerating system running in embodiment two of the invention;

FIG. 5 shows another schematic diagram of the acceleration panel in an embodiment of the invention;

FIG. 6 shows a flow chart of resource cleanup in an embodiment of the invention;

FIG. 7 shows a structural block diagram of an apparatus method for accelerating system running in embodiment four of the invention;

FIG. 8 shows schematically a block diagram of a computing device for performing a method for accelerating system running according to the invention; and

FIG. 9 shows schematically a storage unit for retaining or carrying a program code implementing a method for accelerating system running according to the invention.

### DETAILED DESCRIPTION OF THE INVENTION

In the following the invention will be further described in connection with the drawings and the particular embodiments.

In the following exemplary embodiments of the disclosure will be described in more detail with reference to the accompanying drawings. While the exemplary embodiments of the disclosure are shown in the drawings, it will be appreciated that the disclosure may be implemented in various forms and should not be limited by the embodiments set forth herein. Rather, these embodiments are provided in order for one to be able to more thoroughly understand the disclosure and be able to fully convey the scope of the disclosure to those skilled in the art.

In order to solve the problem that the system running speed can not be increased effectively in the prior art, embodiments of the invention provide a method and apparatus for accelerating system running, wherein the method and apparatus propose a one-key acceleration function, and the function not only can clean up the system memory rapidly, but also can integrate the CPU, memory and I/O of the system, and combinatorially propose a concept of system resources, organize and screen the system's real time resource condition, and intuitively exhibit processes to a user with names of software that they represent, which facilitates the user to free system resources rapidly and increases the system running speed. In the following the solutions of the invention will be described in detail through several specific embodiments.

### Embodiment One

As shown in FIG. 1, an embodiment of the invention provides a method for accelerating system running comprising the following steps.

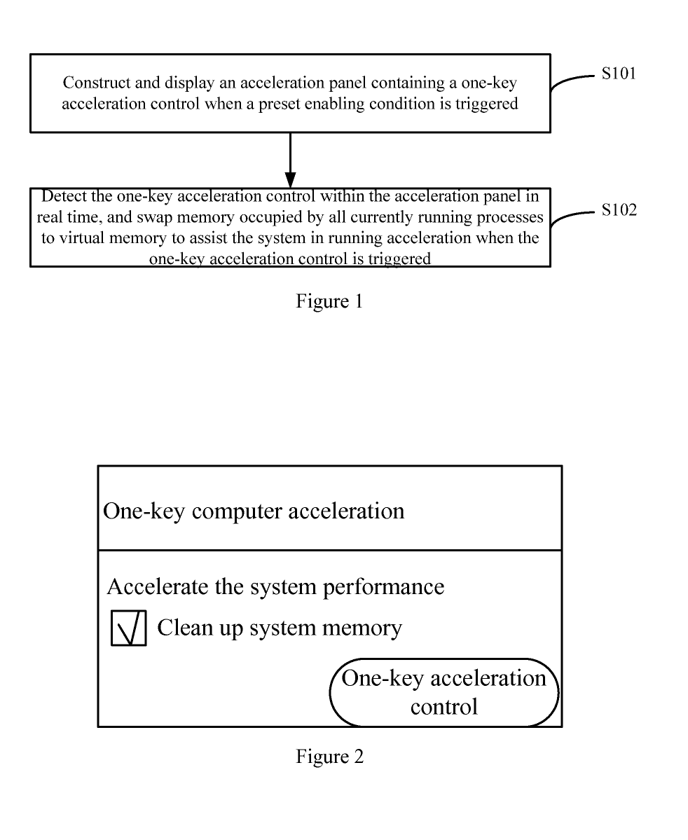

In step S101, an acceleration panel containing a one-key acceleration control is constructed and displayed when a preset enabling condition is triggered; and a schematic diagram of the acceleration panel is as shown in FIG. 2.

In this step, with respect to the enabling triggering condition, the skilled in the art may flexibly configure it as required, and in an embodiment of the invention, the following several preferred triggering ways are given to make the implementation procedure of the invention clearer. In particular, in this step, the way of judging that the preset enabling condition is triggered comprises:

a first way: judging that the preset enabling condition is triggered when it is detected that a startup control laid in a functional area is triggered;

a second way: judging that the preset enabling condition is triggered when it is detected that a set time interval is reached; or

a third way: judging that the preset enabling condition is triggered when it is detected that software is enabled; wherein when it is detected that software is enabled, the startup of the software is paused, and after the execution of the acceleration execution step is finished, the software is run.

Further, in step S101, when the preset enabling condition is triggered, the following operation is further performed: calculating the resource occupancy rate of each currently running process, acquiring the current overall resource occupancy rate based on the resource occupancy rate of each process, and displaying the resource occupancy in the constructed acceleration panel. By this operation, the user is enabled to learn about the current system resource occupancy status, and the intuitive experience is increased.

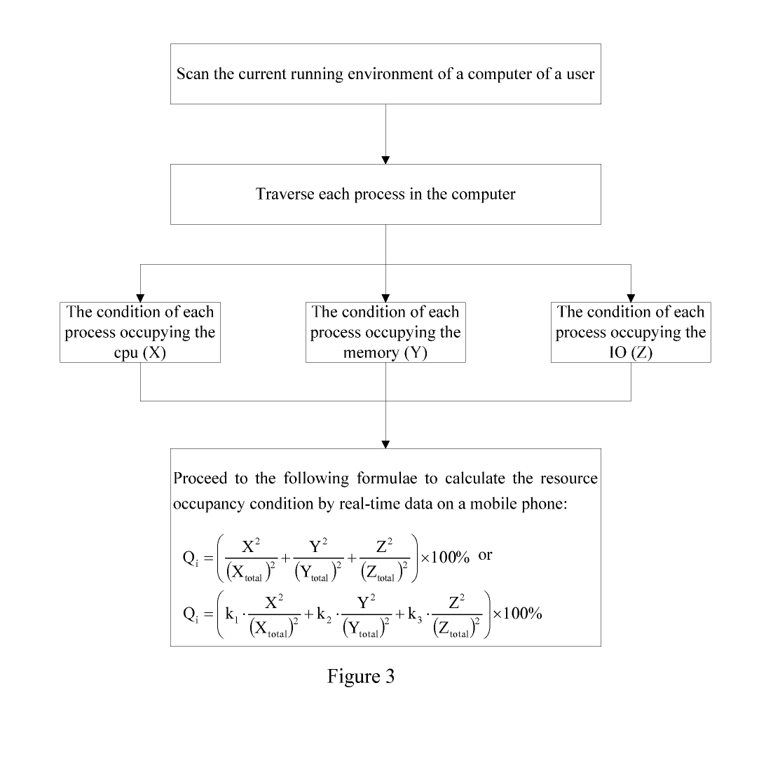

As shown in FIG. 3, the way of calculating the resource occupancy rate of each processes comprises: obtaining the cpu occupancy amount X, the memory occupancy amount Y and the input/output IO occupancy amount Z of a process i, and calculating the resource occupancy rate Qᵢ of the process i based on each obtained parameter, wherein the way of calculating the resource occupancy rate Qᵢ comprises, but is not limited to, two ways given as follows:

$$a first way \text{:} {Q}_{i} = ( \frac{{X}^{2}}{{( {X}_{total} )}^{2}} + \frac{{Y}^{2}}{{( {Y}_{total} )}^{2}} + \frac{{Z}^{2}}{{( {Z}_{total} )}^{2}} ) \times 100 \%$$

wherein X=the cpu occupancy amount of the process, and with respect to the way of calculating the cpu occupancy amount, it is preferably, but not limited to, obtaining the real-time cpu information by invoking the function NtQuerySystemInformation( ), calculating the sum of users and kernels of the process in the current 1 second minus the sum of users and kernels of the process in the previous 1 second, and taking its value as the cpu occupancy amount of the current process i;

Y=the memory occupancy amount of the process, and with respect to the way of calculating the memory occupancy amount, it is preferably, but not limited to, obtaining the real-time memory occupancy amount of the process by invoking the function GetProcessMemoryInfo( ), and taking its value as the memory occupancy amount of the current process i in bytes;

Z=the IO occupancy amount of the process, and with respect to the way of calculating the IO occupancy amount, it is preferably, but not limited to, obtaining the real-time IO information by the function GetProcessIoCounters( ), calculating the number of times of reading I/O in 1 second by the current process divided by the time for reading I/O once, and taking its value as the IO occupancy amount of the process i; and

Xₜₒₜₐₗ is the sum of the X values when the system is running at full load, Yₜₒₜₐₗ is total is of the sum of the Y values when the system is running at full load, and Zₜₒₜₐₗ is the sum the Z values when the system is running at full load, i=1, 2, . . . , N is the total number of processes running currently.

a second way: the invention takes it into account that for a different terminal type, the type of system resources affecting the system running speed may be different. Therefore, in this way of calculating the resource occupancy rate, the concept of weight is added, namely, for a different type of system resources, e.g., cpu, memory and IO, a different weight is configured to reflect the importance of the resources of the corresponding type. The particular calculation way is as follows:

$${Q}_{i} = ( {k}_{1} \cdot \frac{{X}^{2}}{{( {X}_{total} )}^{2}} + {k}_{2} \cdot \frac{{Y}^{2}}{{( {Y}_{total} )}^{2}} + {k}_{3} \cdot \frac{{Z}^{2}}{{( {Z}_{total} )}^{2}} ) \times 100 \% ,$$

Wherein k₁, k₂ and k₃ are pre-configured weights of cpu, memory and IO, respectively.

In step S102, the one-key acceleration control within the acceleration panel is detected in real time, and memory occupied by all currently running processes is swapped to virtual memory to assist the system in running acceleration when the one-key acceleration control is triggered.

Further, when displaying the resource occupancy in step S101, in this step, after the acceleration execution is finished, the size of the memory that is cleaned out is further displayed in the acceleration panel, and in turn the user is facilitated to learn about the resources freed by the acceleration procedure this time.

In summary, in the embodiment of the invention, by swapping memory occupied by all currently running processes to virtual memory and implementing the cleanup of the memory, it is realized that the system running condition can be organized for the user at a fastest speed, and the real-time running speed of the system of the user is increased.

### Embodiment Two

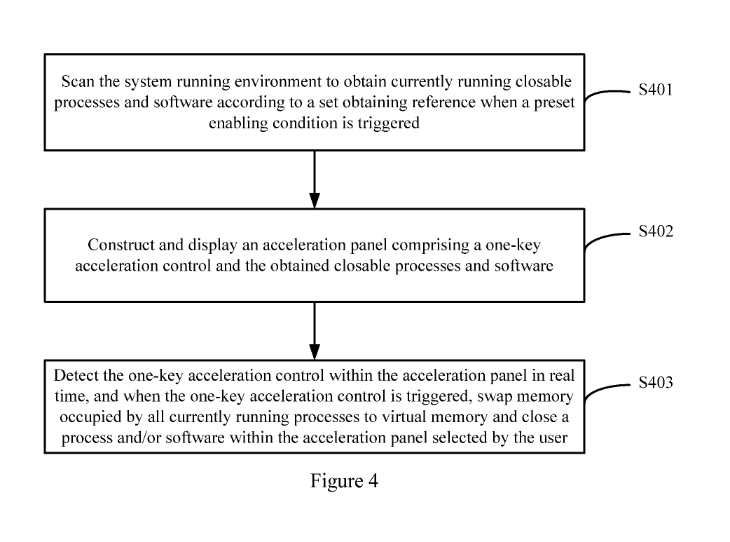

As shown in FIG. 4, an embodiment of the invention provides a method for accelerating system running. The method is an extended scheme of the method described in embodiment one, the scheme comprises all the technical features of embodiment one, and therefore the features already mentioned in embodiment one will not be set forth in detail in the following procedure. The particular implementation procedure of this embodiment is as follows.

In step S401, the system running environment is scanned to obtain currently running closeable processes and software according to a set obtaining reference when a preset enabling condition is triggered.

In this step, scanning the system running environment to obtain currently running closeable processes and software according to a set obtaining reference particularly comprises:

(1) invoking a pre-configured library file and obtaining the closeable process type and software type in the library file when the preset enabling condition is triggered; and

(2) taking the obtained type information as a reference, scanning the system running environment to obtain currently running closeable processes and software.

Therein the closeable process type configured in the library file does not comprise a system service process to prevent the user from closing the system service process and affecting the running of the system; preferably, it does not comprise a system security protection process either to prevent the user from closing for example a relevant process of antivirus software and causing the system to be attacked.

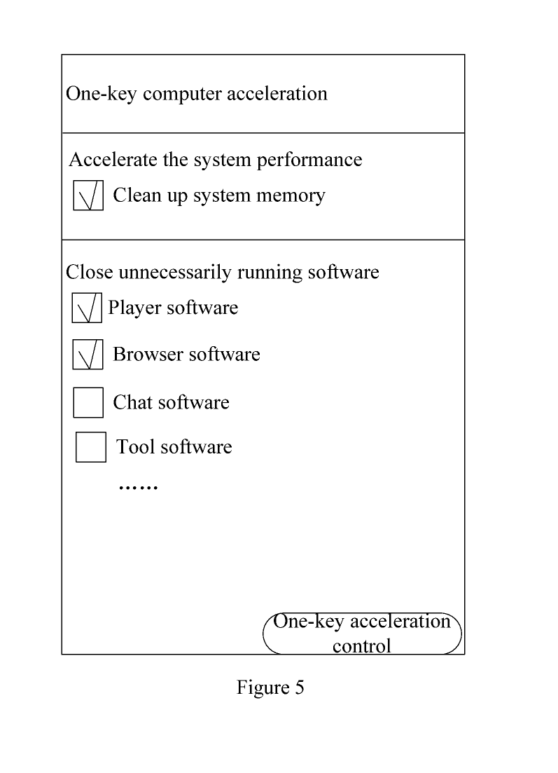

In step S402, an acceleration panel comprising a one-key acceleration control and the obtained closeable processes and software is constructed and displayed for a user to select a process and/or software that needs to be closed and to provide an acceleration triggering key for the user, particularly as shown in FIG. 5.

Preferably, in this step, a redundant process which does not affect the user to use is configured to be in a close selected state by default when displaying the closeable processes and software in the acceleration panel. Therein, the redundant process which does not affect the user to use comprises, but is not limited to, a software supporting process automatically running in a case of the software being not enabled.

And/or in this step, a recorded process and/or software selected at the time of the user's previous acceleration selection is configured to be in a close selected state by default when displaying the closeable processes and software in the acceleration panel.

Therein, when a certain process and/or software is selected by default, the selected process and/or software is arranged ahead, such that the user can learn about the information selected currently by default. Of course, the user may also perform an operation of de-selection on the currently selected information according to the current needs of himself.

Further, in this step, when exhibiting the closeable processes and software in the acceleration panel, they are preferably arranged in an order from high to low in terms of resource occupancy rate; wherein the resource occupancy rate of the exhibited software is the sum of the resource occupancy rate of each process supporting the running of the software.

In step S403, the one-key acceleration control within the acceleration panel is detected in real time, and when the one-key acceleration control is triggered, memory occupied by all currently running processes is swapped to virtual memory and a process and/or software within the acceleration panel selected by the user is closed, to realize assisting the system in running acceleration.

In this step, after the acceleration execution is finished, the size of freed resources and the size of recycled memory are displayed in the acceleration panel, and in turn the user is facilitated to learn about the resources freed by the acceleration procedure this time.

Preferably, in this embodiment, the operation of “swapping memory occupied by all currently running processes to virtual memory” may be further taken as an option, and the user can select whether to swap memory as required. Of course, in order to facilitate the system acceleration, the option of memory swapping is usually set to be an option selected by default.

Preferably, in this embodiment, when resources are calculated, the calculation way as described in the second way in embodiment one is adopted preferably, because weight values of different types of resources are added in the second computational way, such that the calculated resource occupancy ratio corresponds to the resource more relevant to the system running, the acquired result of the resource occupancy ratio depends more on the resource with a larger weight, and when the resource occupancy ratio is high, the user can be prompted to close more processes and/or software running unnecessarily, thereby assisting the system in running acceleration.

In summary, in the embodiment of the invention, by swapping memory occupied by all currently running processes to virtual memory and implementing the cleanup of the memory, and by closing unnecessary processes and software and implementing the cleanup of system resources, it is in turn achieved that the system running condition can be organized for the user at a fastest speed, redundant resources are freed, and the real-time running speed of the system of the user is increased.

### Embodiment Three

An embodiment of the invention provides a method for accelerating system running, which is a further elucidation in combination with a specific example based on the accelerating method as described in embodiment two. Of course, the specific implementation as described in the example is not a unique implementation of the method of the invention, it is used for explaining the invention, but not for uniquely defining the invention, and in particular comprises:

In this embodiment, when the user's mouse moves to a one-key acceleration function startup control laid in a functional area, a one-key acceleration panel is constructed and displayed, and in the acceleration panel, a one-key acceleration control and information of currently running processes and software for a user to perform close selection by are exhibited. The user can check selectively, the first usage will be subject to the default configuration, afterwards, the user's check condition will be recorded locally each time, and when the user opens it again, the previous check condition will be used as a reference.

After the user clicks the one-key acceleration control in the acceleration panel, memory occupied by all currently running processes will be swapped to virtual memory, and the process and/or software selected by the user to be closed will be cleaned up, thus realizing the release of resources.

Preferably, the one-key acceleration principle proposed by the invention may be integrated with software enabling, that is, when the software is enabled, system running resources are organized, enabling speed is accelerated, and the software is started after the acceleration is finished, that is, after the environment is optimized, the software is started to run by using the function SetProcessWorkingSetSize of Windows APIs to ensure that the software is running in an optimized system environment, thereby increasing the software running speed.

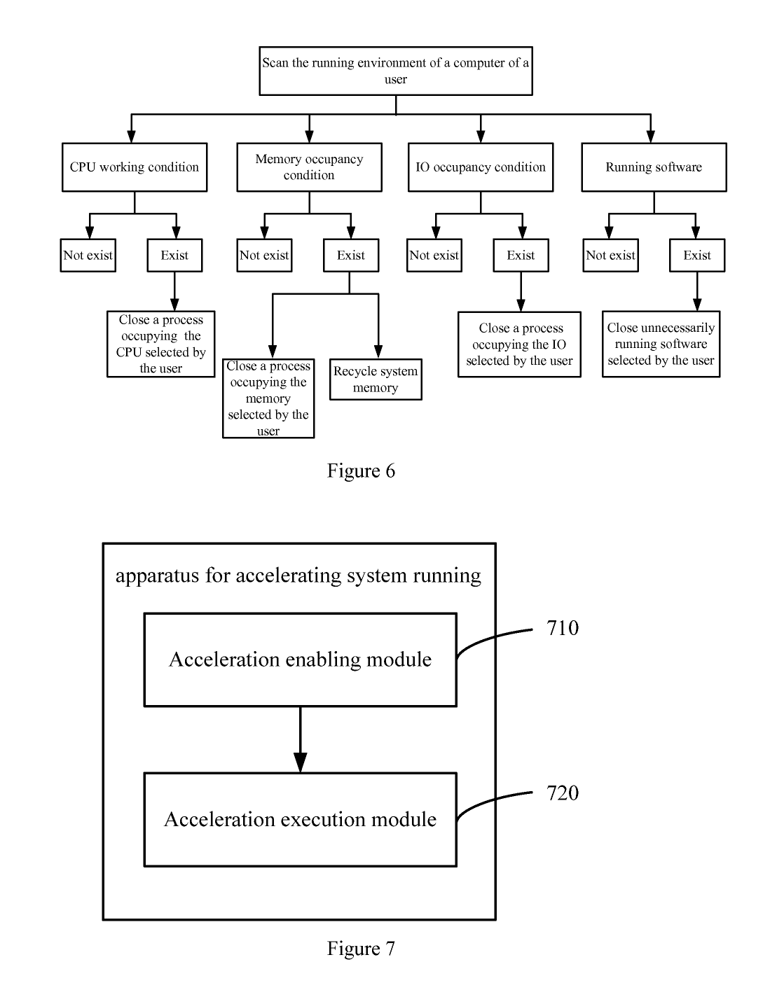

In particular, as shown in FIG. 6, the flow of realizing the cleanup of resources as described in this embodiment comprises:

1) scanning the user's current computer environment: primarily detecting system resources such as the cpu running condition, the memory occupancy condition, the computer Io occupancy condition, and the currently running software, etc.;

2) after the environment is detected, optimizing the current system environment, and increasing the computer running speed, wherein the means of optimization are: according to the user's selection, closing an unnecessary computer process occupying CPU, closing an unnecessary computer process occupying memory and at the same time recycling the system memory, closing a computer process occupying IO too much, and closing unnecessary running software, etc.

### Embodiment Four

As shown in FIG. 7, an embodiment of the invention provides an apparatus for accelerating system running, comprising:

an acceleration enabling module 710 configured to construct and display an acceleration panel containing a one-key acceleration control when a preset enabling condition is triggered; and

an acceleration execution module 720 configured to detect the one-key acceleration control within the acceleration panel in real time, and swap memory occupied by all currently running processes to virtual memory to assist the system in running acceleration when the one-key acceleration control is triggered.

In particular, in the apparatus as described in this embodiment, with respect to the enabling triggering condition, the skilled in the art may flexibly configure it as required, and in an embodiment of the invention, the following several preferred triggering ways are given to make the implementation procedure of the invention clearer. In particular, in the acceleration enabling module 710, the way of judging that the preset enabling condition is triggered comprises:

a first way: judging that the preset enabling condition is triggered when it is detected that a startup control laid in a functional area is triggered;

a second way: judging that the preset enabling condition is triggered when it is detected that a set time interval is reached; or

a third way: judging that the preset enabling condition is triggered when it is detected that software is enabled; wherein when it is detected that software is enabled, the startup of the software is paused, and after the execution of the acceleration execution step is finished, the software is run.

Further, in this embodiment, when the preset enabling condition is triggered, the acceleration enabling module 710 further performs the following operation: calculating the resource occupancy rate of each currently running process, acquiring the current overall resource occupancy rate based on the resource occupancy rate of each process, and displaying the resource occupancy in the constructed acceleration panel. By this operation, the user is enabled to learn about the current system resource occupancy status, and the intuitive experience is increased.

As shown in FIG. 3, the way of calculating the resource occupancy rate of each process comprises: obtaining the cpu occupancy amount X, the memory occupancy amount Y and the input/output IO occupancy amount Z of a process i, and calculating the resource occupancy rate Qᵢ of the process i based on each obtained parameter, wherein the way of calculating the resource occupancy rate Qᵢ comprises, but is not limited to, two ways given as follows:

$$a first way \text{:} {Q}_{i} = ( \frac{{X}^{2}}{{( {X}_{total} )}^{2}} + \frac{{Y}^{2}}{{( {Y}_{total} )}^{2}} + \frac{{Z}^{2}}{{( {Z}_{total} )}^{2}} ) \times 100 \%$$

wherein X=the cpu occupancy amount of the process, and with respect to the way of calculating the cpu occupancy amount, it is preferably, but not limited to, obtaining the real-time cpu information by invoking the function NtQuerySystemInformation( ), calculating the sum of users and kernels of the process in the current 1 second minus the sum of users and kernels of the process in the previous 1 second, and taking its value as the cpu occupancy amount of the current process i;

Y=the memory occupancy amount of the process, and with respect to the way of calculating the memory occupancy amount, it is preferably, but not limited to, obtaining the real-time memory occupancy amount of the process by invoking the function GetProcessMemoryInfo( ), and taking its value as the memory occupancy amount of the current process i in bytes;

Z=the IO occupancy amount of the process, and with respect to the way of calculating the IO occupancy amount, it is preferably, but not limited to, obtaining the real-time IO information by the function GetProcessIoCounters( ), calculating the number of times of reading I/O in 1 second by the current process divided by the time for reading I/O once, and taking its value as the IO occupancy amount of the process i; and

Xₜₒₜₐₗ is the sum of the X values when the system is running at full load, Yₜₒₜₐₗ is total is of the sum of the Y values when the system is running at full load, and Zₜₒₜₐₗ is the sum the Z values when the system is running at full load, i=1, 2, . . . , N is the total number of processes running currently.

a second way: the invention takes it into account that for a different terminal type, the type of system resources affecting the system running speed may be different. Therefore, in this way of calculating the resource occupancy rate, the concept of weight is added, namely, for a different type of system resources, e.g., cpu, memory and IO, a different weight is configured to reflect the importance of the resources of the corresponding type. The particular calculation way is as follows:

$${Q}_{i} = ( {k}_{1} \cdot \frac{{X}^{2}}{{( {X}_{total} )}^{2}} + {k}_{2} \cdot \frac{{Y}^{2}}{{( {Y}_{total} )}^{2}} + {k}_{3} \cdot \frac{{Z}^{2}}{{( {Z}_{total} )}^{2}} ) \times 100 \% ,$$

Wherein k₁, k₂ and k₃ are pre-configured weights of cpu, memory and IO, respectively.

Further, in this embodiment, if the acceleration enabling module 710 displays the resource occupancy, after the acceleration execution is finished, the acceleration execution module 720 further displays the size of the memory that is cleaned out in the acceleration panel, and in turn facilitates the user to learn about the resources freed by the acceleration procedure this time.

In summary, in the embodiment of the invention, by swapping memory occupied by all currently running processes to virtual memory and implementing the cleanup of the memory, it is realized that the system running condition can be organized for the user at a fastest speed, and the real-time running speed of the system of the user is increased.

### Embodiment Five

An embodiment of the invention provides an apparatus for accelerating system running The apparatus is an extended scheme of the apparatus described in embodiment four, the scheme comprises all the technical features of embodiment four, and therefore the features already mentioned in embodiment four will not be set forth in detail in the following procedure.

To continue, as shown in FIG. 7, the particular implementation procedure of this embodiment comprises:

the acceleration enabling module 710 configured to scan the system running environment to obtain currently running closeable processes and software according to a set obtaining reference when a preset enabling condition is triggered, and construct and display an acceleration panel comprising a one-key acceleration control and the obtained closeable processes and software for a user to select a process and/or software that needs to be closed and to provide an acceleration triggering key for the user; and

the acceleration execution module 720 configured to detect the one-key acceleration control within the acceleration panel in real time, and when the one-key acceleration control is triggered, swap memory occupied by all currently running processes to virtual memory and close a process and/or software within the acceleration panel selected by the user, to realize assisting the system in running acceleration.

Preferably, in this embodiment, that the acceleration enabling module 710 scans the system running environment to obtain currently running closeable processes and software according to a set obtaining reference particularly comprises:

(1) invoking a pre-configured library file and obtaining the closeable process type and software type in the library file when the preset enabling condition is triggered; and

(2) taking the obtained type information as a reference, scanning the system running environment to obtain currently running closeable processes and software.

Therein the closeable process type configured in the library file does not comprise a system service process to prevent the user from closing the system service process and affecting the running of the system; preferably, it does not comprise a system security protection process either to prevent the user from closing for example a relevant process of antivirus software and causing the system to be attacked.

Preferably, in this embodiment, the acceleration enabling module 710 configures a redundant process which does not affect the user to use to be in a close selected state by default when displaying the closeable processes and software in the acceleration panel; and/or configures a recorded process and/or software selected at the time of the user's previous acceleration selection to be in a close selected state by default when displaying the closeable processes and software in the acceleration panel. Therein, the redundant process which does not affect the user to use comprises, but is not limited to, a software supporting process automatically running in a case of the software being not enabled.

Therein, when a certain process and/or software is selected by default, the selected process and/or software is arranged ahead, such that the user can learn about the information selected currently by default. Of course, the user may also perform an operation of de-selection on the currently selected information according to the current needs of himself.

Further, in this embodiment, when exhibiting the closeable processes and software in the acceleration panel, the acceleration enabling module 710 preferably arranges them in an order from high to low in terms of resource occupancy rate; wherein the resource occupancy rate of the exhibited software is the sum of the resource occupancy rate of each process supporting the running of the software.

Further, in this embodiment, after the acceleration execution is finished, the acceleration execution module 720 displays the size of freed resources and the size of recycled memory in the acceleration panel, which in turn facilitates the user to learn about the resources freed by the acceleration procedure this time.

Preferably, in this embodiment, the operation of “swapping memory occupied by all currently running processes to virtual memory” may be further taken as an option, and the user can select whether to swap memory as required. Of course, in order to facilitate the system acceleration, the option of memory swapping is usually set to be an option selected by default.

Preferably, in this embodiment, when resources are calculated, the calculation way as described in the second way in embodiment four is adopted preferably, because weight values of different types of resources are added in the second computational way, such that the calculated resource occupancy ratio corresponds to the resource more relevant to the system running, the acquired result of resource occupancy ratio depends more on the resource with a larger weight, and when the resource occupancy ratio is high, the user can be induced to close more processes and/or software running unnecessarily, thereby assisting the system in running acceleration.

In summary, in the embodiment of the invention, by swapping memory occupied by all currently running processes to virtual memory and implementing the cleanup of the memory, and by closing unnecessary processes and software and implementing the cleanup of system resources, it is in turn achieved that the system running condition can be organized for the user at a fastest speed, redundant resources are freed, and the real-time running speed of the system of the user is increased.

The algorithms and displays provided here are not inherently related to any specific computer, virtual system or other device. Various general-purpose systems may also be used with the teachings herein. According to the above description, the structure required for constructing such systems is obvious. In addition, the invention is not directed to any specific programming language. It should be understood that the content of the invention described herein may be carried out utilizing various programming languages, and that the above description for a specific language is for the sake of disclosing preferred embodiments of the invention.

In the specification provided herein, a plenty of particular details are described. However, it can be appreciated that an embodiment of the invention may be practiced without these particular details. In some embodiments, well known methods, structures and technologies are not illustrated in detail so as not to obscure the understanding of the specification.

Similarly, it shall be appreciated that in order to simplify the disclosure and help the understanding of one or more of all the inventive aspects, in the above description of the exemplary embodiments of the invention, sometimes individual features of the invention are grouped together into a single embodiment, figure or the description thereof. However, the disclosed methods should not be construed as reflecting the following intention, namely, the claimed invention claims more features than those explicitly recited in each claim. More precisely, as reflected in the following claims, an aspect of the invention lies in being less than all the features of individual embodiments disclosed previously. Therefore, the claims complying with a particular implementation are hereby incorporated into the particular implementation, wherein each claim itself acts as an individual embodiment of the invention.

It may be appreciated to those skilled in the art that modules in a device in an embodiment may be changed adaptively and arranged in one or more device different from the embodiment. Modules or units or assemblies may be combined into one module or unit or assembly, and additionally, they may be divided into multiple sub-modules or sub-units or subassemblies. Except that at least some of such features and/or procedures or units are mutually exclusive, all the features disclosed in the specification (including the accompanying claims, abstract and drawings) and all the procedures or units of any method or device disclosed as such may be combined employing any combination. Unless explicitly stated otherwise, each feature disclosed in the specification (including the accompanying claims, abstract and drawings) may be replaced by an alternative feature providing an identical, equal or similar objective.

Furthermore, it can be appreciated to the skilled in the art that although some embodiments described herein comprise some features and not other features comprised in other embodiment, a combination of features of different embodiments is indicative of being within the scope of the invention and forming a different embodiment. For example, in the following claims, any one of the claimed embodiments may be used in any combination.

Embodiments of the individual components of the invention may be implemented in hardware, or in a software module running on one or more processors, or in a combination thereof. It will be appreciated by those skilled in the art that, in practice, some or all of the functions of some or all of the components in a system running acceleration device according to individual embodiments of the invention may be realized using a microprocessor or a digital signal processor (DSP). The invention may also be implemented as a device or apparatus program (e.g., a computer program and a computer program product) for carrying out a part or all of the method as described herein. Such a program implementing the invention may be stored on a computer readable medium, or may be in the form of one or more signals. Such a signal may be obtained by downloading it from an Internet website, or provided on a carrier signal, or provided in any other form.

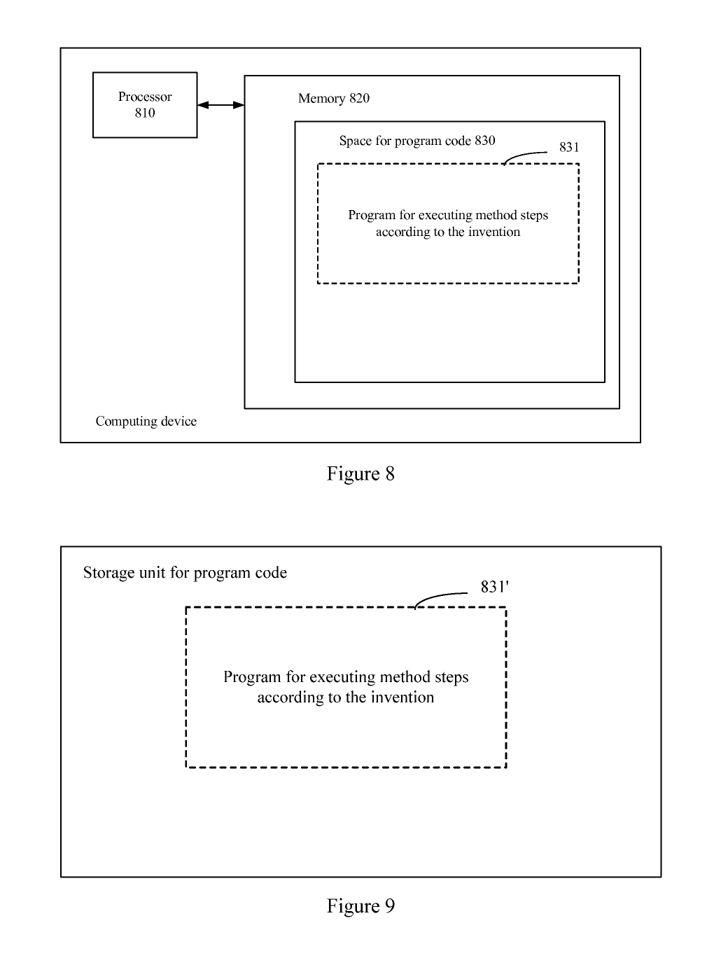

For example, FIG. 8 shows a computing device which may carry out a system running acceleration method according to the invention. The computing device traditionally comprises a processor 810 and a computer program product or a computer readable medium in the form of a memory 820. The memory 820 may be an electronic memory such as a flash memory, an EEPROM (electrically erasable programmable read-only memory), an EPROM, a hard disk or a ROM. The memory 820 has a memory space 830 for a program code 831 for carrying out any method steps in the methods as described above. For example, the memory space 830 for a program code may comprise individual program codes 831 for carrying out individual steps in the above methods, respectively. The program codes may be read out from or written to one or more computer program products. These computer program products comprise such a program code carrier as a hard disk, a compact disk (CD), a memory card or a floppy disk. Such a computer program product is generally a portable or stationary storage unit as described with reference to FIG. 9. The storage unit may have a memory segment, a memory space, etc. arranged similarly to the memory 820 in the computing device of FIG. 8. The program code may for example be compressed in an appropriate form. In general, the storage unit comprises a computer readable code 831′, i.e., a code which may be read by e.g., a processor such as 810, and when run by a computing device, the codes cause the computing device to carry out individual steps in the methods described above.

“An embodiment”, “the embodiment” or “one or more embodiments” mentioned herein implies that a particular feature, structure or characteristic described in connection with an embodiment is included in at least one embodiment of the invention. In addition, it is to be noted that, examples of a phrase “in an embodiment” herein do not necessarily all refer to one and the same embodiment.

It is to be noted that the above embodiments illustrate rather than limit the invention, and those skilled in the art may design alternative embodiments without departing the scope of the appended claims. In the claims, any reference sign placed between the parentheses shall not be construed as limiting to a claim. The word “comprise” does not exclude the presence of an element or a step not listed in a claim. The word “a” or “an” preceding an element does not exclude the presence of a plurality of such elements. The invention may be implemented by means of a hardware comprising several distinct elements and by means of a suitably programmed computer. In a unit claim enumerating several apparatuses, several of the apparatuses may be embodied by one and the same hardware item. Use of the words first, second, and third, etc. does not mean any ordering. Such words may be construed as naming.

Furthermore, it is also to be noted that the language used in the description is selected mainly for the purpose of readability and teaching, but not selected for explaining or defining the subject matter of the invention. Therefore, for those of ordinary skills in the art, many modifications and variations are apparent without departing the scope and spirit of the appended claims. For the scope of the invention, the disclosure of the invention is illustrative, but not limiting, and the scope of the invention is defined by the appended claims.

1. An apparatus for accelerating system running, comprising:
at least one processor; and
one non-transitory computer readable medium coupled to the processor, the medium storing instructions that when executed by the processor cause the processor to perform operations for accelerating system running, which comprise:
an acceleration enabling step of constructing and displaying an acceleration panel containing a one-key acceleration control when a preset enabling condition is triggered; and
an acceleration execution step of detecting the one-key acceleration control within the acceleration panel in real time, and swapping memory occupied by all currently running processes to virtual memory to assist the system in running acceleration when the one-key acceleration control is triggered.

2. The apparatus as claimed in claim 1, wherein
the acceleration enabling step further comprises: scanning the system running environment to obtain currently running closeable processes and software according to a set obtaining reference when the preset enabling condition is triggered, and exhibiting the obtained closeable processes and software via the acceleration panel for a user to perform a close selection; and
the acceleration execution step further comprises: closing a selected process and/or software within the acceleration panel and recycling memory and resources of the system when the one-key acceleration control is triggered.

3. The apparatus as claimed in claim 2, wherein the acceleration enabling step further comprises: invoking a pre-configured library file and obtaining a closeable process type and software type when the preset enabling condition is triggered; and taking the obtained type information as a reference, scanning the system running environment to obtain currently running closeable processes and software, and exhibiting the obtained closeable processes and software via the acceleration panel for the user to perform the close selection.

4. The apparatus as claimed in claim 2, wherein the acceleration enabling step further comprises: configuring a redundant process which does not affect the user to use to be in a close selected state by default when exhibiting the closeable processes and software in the acceleration panel.

5. The apparatus as claimed in claim 2, wherein the acceleration enabling step further comprises: when the preset enabling condition is triggered, calculating a resource occupancy rate of each currently running process, acquiring a current overall resource occupancy rate based on the resource occupancy rate of each process, and displaying the resource occupancy in the constructed acceleration panel.

6. The apparatus as claimed in claim 5, wherein the way of calculating the resource occupancy rate of each process comprises:
obtaining a cpu occupancy amount X, a memory occupancy amount Y and an input/output IO occupancy amount Z of a process i, and calculating a resource occupancy rate Qi of the process i based on each obtained occupancy amount.

7. The apparatus as claimed in claim 5, wherein the acceleration enabling step further comprises: when exhibiting the closeable processes and software in the acceleration panel, arranging them in an order from high to low in terms of resource occupancy rate; wherein the resource occupancy rate of the exhibited software is the sum of the resource occupancy rate of each process supporting the running of the software.

8. The apparatus as claimed in claim 5, wherein the acceleration execution step further comprises: displaying the size of freed resources and the size of recycled memory in the acceleration panel after the acceleration execution is finished.

9. The apparatus as claimed in claim 1, wherein the acceleration enabling step further comprises: judging that the preset enabling condition is triggered when it is detected that a startup control laid in a functional area is triggered; or judging that the preset enabling condition is triggered when it is detected that a set time interval is reached; or judging that the preset enabling condition is triggered when it is detected that software is enabled;
wherein when it is detected that software is enabled, the startup of the software is paused, and after the execution of the acceleration execution module is finished, the software is run.

10. A method for accelerating system running, comprising:
an acceleration enabling step of constructing and displaying an acceleration panel containing a one-key acceleration control when a preset enabling condition is triggered; and
an acceleration execution step of detecting the one-key acceleration control within the acceleration panel in real time, and swapping memory occupied by all currently running processes to virtual memory to assist the system in running acceleration when the one-key acceleration control is triggered.

11. The method as claimed in claim 10, wherein
the acceleration enabling step further comprises: scanning the system running environment to obtain currently running closeable processes and software according to a set reference when the preset enabling condition is triggered, and exhibiting the obtained closeable processes and software via the acceleration panel for a user to perform a close selection; and
the acceleration execution step further comprises: closing a selected process and/or software within the acceleration panel and recycling memory and resources of the system when the one-key acceleration control is triggered.

12. The method as claimed in claim 11, wherein the acceleration enabling step further comprises:
invoking a pre-configured library file and obtaining a closeable process type and software type when the preset enabling condition is triggered; and
taking the obtained type information as a reference, scanning the system running environment to obtain currently running closeable processes and software, and exhibiting the obtained closeable processes and software via the acceleration panel for the user to perform the close selection.

13. The method as claimed in claim 11, wherein the acceleration enabling step further comprises: configuring a redundant process which does not affect the user to use to be in a close selected state by default when exhibiting the closeable processes and software in the acceleration panel.

14. The method as claimed in claim 11, wherein the acceleration enabling step further comprises: when the preset enabling condition is triggered, calculating a resource occupancy rate of each currently running process, acquiring a current overall resource occupancy rate based on the resource occupancy rate of each process, and displaying the resource occupancy in the constructed acceleration panel.

15. The method as claimed in claim 14, wherein the way of calculating the resource occupancy rate of each process comprises: obtaining a cpu occupancy amount X, a memory occupancy amount Y and an input/output IO occupancy amount Z of a process i, and calculating a resource occupancy rate Qi of the process i based on each obtained occupancy amount.

16. The method as claimed in claim 14, wherein the acceleration enabling step further comprises: when exhibiting the closeable processes and software in the acceleration panel, arranging them in an order from high to low in terms of resource occupancy rate; wherein the resource occupancy rate of the exhibited software is the sum of the resource occupancy rate of each process supporting the running of the software.

17. The method as claimed in claim 14, wherein the acceleration execution step further comprises: displaying the size of freed resources and the size of recycled memory in the acceleration panel after the acceleration execution is finished.

18. The method as claimed in claim 10, wherein in the acceleration enabling step, the way of judging that the preset enabling condition is triggered further comprises:
judging that the preset enabling condition is triggered when it is detected that a startup control laid in a functional area is triggered; or judging that the preset enabling condition is triggered when it is detected that a set time interval is reached; or judging that the preset enabling condition is triggered when it is detected that software is enabled;
wherein when it is detected that software is enabled, the startup of the software is paused, and after the execution of the acceleration execution step is finished, the software is run.

19. (canceled)

20. A non-transitory computer readable medium having instructions stored thereon that, when executed by at least one processor, cause the at least one processor to perform operations for accelerating system running, which comprises the steps of:
constructing and displaying an acceleration panel containing a one-key acceleration control when a preset enabling condition is triggered; and
detecting the one-key acceleration control within the acceleration panel in real time, and swapping memory occupied by all currently running processes to virtual memory to assist the system in running acceleration when the one-key acceleration control is triggered.
